(19) United States
(12) Patent Application Publication
(10) Pub. No.: US 2007/0174106 A1
(43) Pub. Date: Jul. 26, 2007

(54) Method for reducing implementation time for policy based systems management tools

(76) Inventors: Chris Aniszczyk, Austin, TX (US); David Perry Greene, Austin, TX (US); Devin Ann Lindsey, Burlington, MA (US); Pierre Francois Padovani, Austin, TX (US); Borna Safabakhsh, Austin, TX (US)

Correspondence Address: IBM CORP (YA);C/O YEE & ASSOCIATES PC, P.O. BOX 802333, DALLAS, TX, 75380, US

(21) Appl. No.: 11/340,446

(22) Filed: Jan. 26, 2006

(51) Int. Cl. G07G 1/00; G06F 17/30

(52) U.S. Cl. 705/10

(57) ABSTRACT

A computer implemented method, apparatus, and computer program product for effectively reducing a complicated problem space to enable faster implementation of system management software, and in particular, policy management for security software. The policy management tool of the present invention receives input from a user to configure a policy model, wherein the policy model is configured according to a set of policy requirements. The policy management tool presents a graphical view of a policy model according to the input from the user, wherein the graphical view allows the user to visualize internals of the policy model as a whole. The policy management tool performs validations on the policy model against requirements of the set of policy requirements. A simulation of the policy model may then be performed to determine the validity of the policy model and generate real test results feedback at a time the policy model is configured.

### BACKGROUND OF THE INVENTION

1. Field of the Invention

The present invention relates generally to an improved data processing system, and in particular, to a method for reducing implementation time for policy based system management tools.

2. Description of the Related Art

As computer systems become increasingly complex, the task of managing access to various system resources also becomes more difficult. Access management may be implemented using security policies, which define objectives, requirements for system configurations, and rules of behavior for users and administrators to ensure security of computer systems in an organization. A security policy is concerned with assigning, to a specific user, specific rights to use particular resources in a particular context. Even for a small or medium sized business, implementing security policies in software is a complex and time consuming task. An implementation may take many months, even up to a year. Because the basic parameters of the software enable an exceptionally large number of possible policy conditions, the potential space is enormous. Moreover, policies tend to be driven by business issues and needs but within the context of information system resources. In addition, those policies must be converted into conditional specifications and ultimately executable code. Therefore, the challenge of articulating and communicating the scope and logic of a security policy as well as understanding the potential conflicts different security policies may create, both within the organization and within the software implementation, leads to a very time consuming process.

Current systems rely on a manual text interface and much time consuming dialog among different customer stakeholders, as well as different members of the implementation team, to implement security policies. Existing approaches which could offer some relief by reducing some of the problems with implementing security polices include Role Based Access Control (RBAC) tools to provide representation and graphical user interfaces (GUIs) to enable collaboration Computer Supported Collaborative Work (CSCW). However, no existing approaches provide implementations that are easily applicable to the space, nor do they address the broader problem of moving users from a high level of choices down to a highly reduced set of shared acceptable alternatives that can be easily implemented with reduced likelihood of errors.

### SUMMARY OF THE INVENTION

Embodiments of the present invention provide a computer implemented method, apparatus, and computer program product for effectively reducing a complicated problem space to enable faster implementation of system management software, and in particular, policy management for security software. The policy management tool of the present invention receives input from a user to configure a policy model, wherein the policy model is configured according to a set of policy requirements. The policy management tool presents a graphical view of a policy model according to the input from the user, wherein the graphical view allows the user to visualize internals of the policy model as a whole. The policy management tool performs validations on the policy model against requirements of the set of policy requirements. A simulation of the policy model may then be performed to determine the validity of the policy model. The simulation generates real test results feedback at a time the policy model is configured.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 is a block diagram of a data processing system used to implement aspects of the present invention;

FIG. 3 is a diagram of a known model-view-controller paradigm;

FIGS. 4A-4B depict a diagram of an exemplary policy management architecture for reducing implementation time for policy based system management tools in accordance with an illustrative embodiment of the present invention;

FIGS. 5A-5B depict a diagram of a flexible graphical view in accordance with an illustrative embodiment of the present invention; and

FIG. 6 is a flowchart of a process for reducing implementation time for policy-based system management tools in accordance with an illustrative embodiment of the present invention.

### DETAILED DESCRIPTION OF THE PREFERRED EMBODIMENT

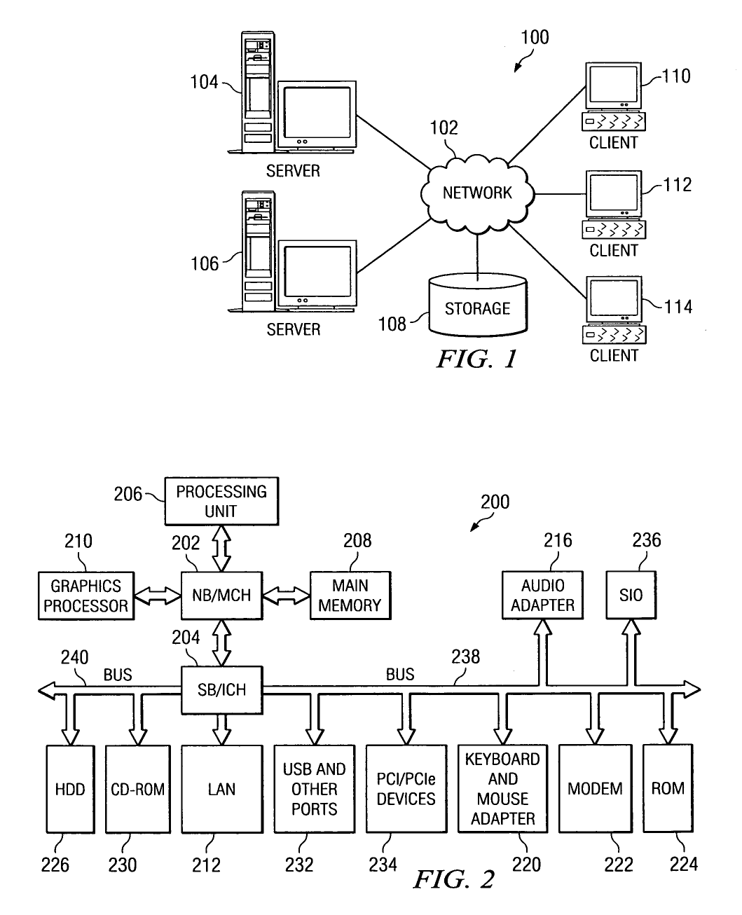

With reference now to the figures and in particular with reference to FIGS. 1-2, exemplary diagrams of data processing environments are provided in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eserver™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for embodiments of the present invention are performed by processing unit 206 using computer usable program code, which may be located in a memory such as, for example, main memory 208, ROM 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course, the bus system may be implemented using any type of communication fabric or architecture that provides for a transfer of data between different components or devices attached to the fabric or architecture. A communication unit may include one or more devices used to transmit and receive data, such as modem 222 or network adapter 212 of FIG. 2. A memory may be, for example, main memory 208, ROM 224, or a cache such as found in NB/MCH 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

Existing policy management systems require users to build relationships by querying the policy model on a box by box basis. The user, in building relationships one by one, must retain aspects of the policy model in the user's memory before a user can obtain a big picture understanding of how the system is operating. Thus, the speed and capacity of what the user understands about the system is based on the user's memory ability. In addition, with existing systems, a user may not be able to determine the consequences of a modification upon a policy or inside whatever space that policy lies. Thus, a user modifies a policy without knowing the results of the changes.

In contrast with such existing systems, a policy management tool is provided in accordance with exemplary embodiments of the present invention for implementing policies in system management software, and in particular, for policy management of security software. The policy management tool of the present invention reduces the time needed for implementing security policies in system software and reduces the complexity of the policy implementation by providing a graphical interface for displaying policy models visually. The graphical interface of the present invention allows users to quickly and easily understand the internals of the policy model as a whole (e.g., the user may view the relationships between employees and objects being managed by the policies), modify the policies in an efficient manner, and view the effects the policy modifications would have on other objects. The actual policies created and modified using the policy management tool of the present invention are consumed by the software in the same manner as a policy created using existing systems. However, the policy management tool of the present invention allows the user to create and modify polices using less knowledge, time, and effort on the part of the user to create the same policy.

The policy management tool of the present invention also provides an expert system for identifying syntactic problems with the policies, as well as for prioritizing alternatives to provide best-choice implementation options to the users. An expert system is an artificial intelligence application that uses a knowledge base of human expertise for problem solving. The expert system solves problems by mimicking the decision-making ability of the human experts by relying on and manipulating large stores of expert knowledge. When the user builds or modifies a policy using the graphical interface, the expert system monitors the user's input to detect potential syntactic problems and alert the user via the graphical interface. The expert system also analyzes the policy to determine the semantic meaning in the relationships, and alerts the user to invalid or inconsistent inter-object structures. The expert system also evaluates whether the configuration techniques used to implement the policy are consistent with best practice patterns, and provides intelligent recommendations via the graphical interface of better options. In this manner, the expert system enables the user to intelligently choose among configurations to further facilitate implementation agreements.

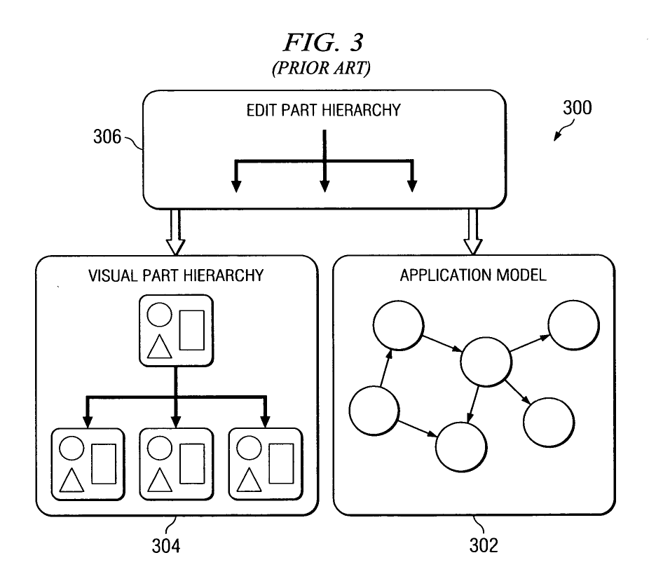

FIG. 3 is a diagram of a known model-view-controller (MVC) paradigm. MVC paradigm 300 comprises a standard approach to presenting data graphically, and may be used to work with any type of data. In particular, the MVC paradigm separates the application object (model) from the way the model is graphical represented to the user (view). The model-view-controller also separates the model and the view from the way in which the user controls the model (controller).

The model, such as application model 302, represents a real-world process or system and describes how the system works. The model comprises data and functions that operate on the data. The model also manages one or more data elements and responds to queries about the state of the model and instructions to change state.

The view is a visual representation of the model. In this illustrative example, visualparts hierarchy 304 presents the view of the model to the user through a combination of graphics and text.

The controller is the means by which the user interacts with the application. The controller mediates and provides the communication bridge between the application model 302 and the visualparts hierarchy 304. Upon receiving user input, the controller, or editparts hierarchy 306 in this illustrative example, maps these user actions into commands that are sent to the model and/or view to effect the appropriate change. Editparts hierarchy 306 may comprise various controller levels, wherein the top level controller allows child controllers to be created for each element in a model hierarchy tree. The controllers may build and modify the view according to the contents of the model.

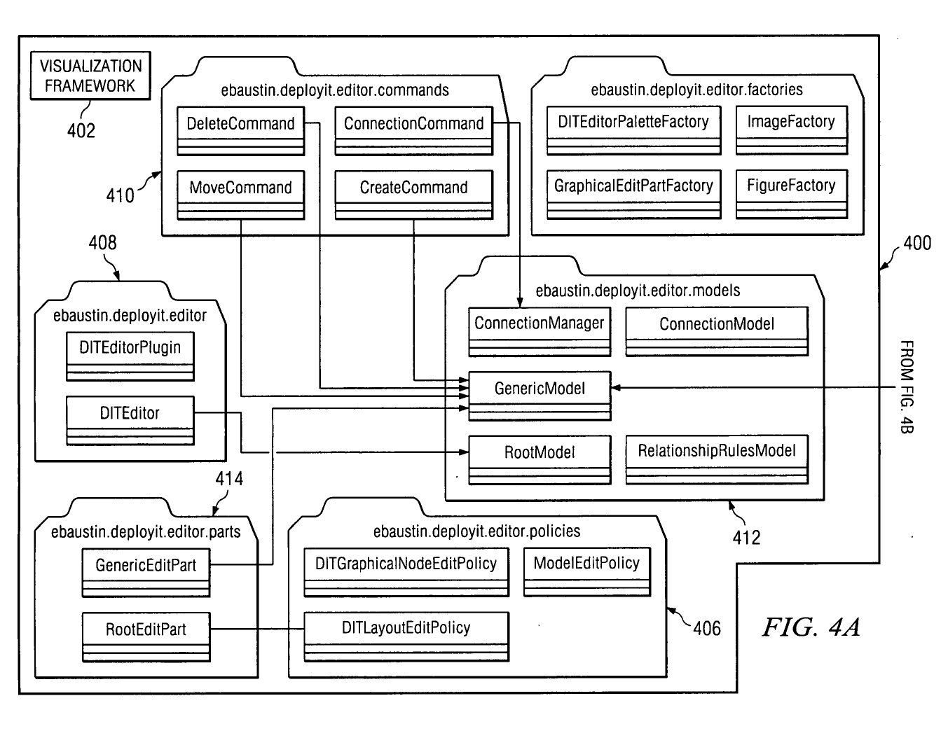

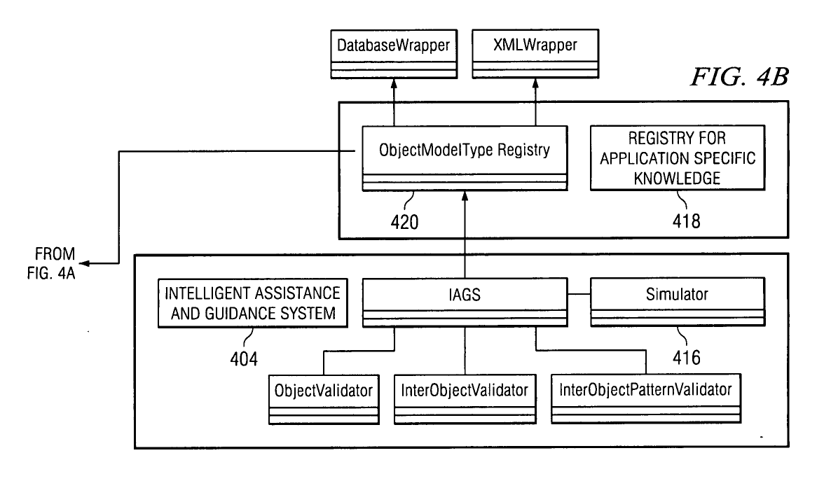

FIGS. 4A-4B depict a diagram of an exemplary policy management architecture for reducing implementation time for policy based system management tools in accordance with an illustrative embodiment of the present invention. In particular, policy management architecture 400 is used to describe the structure of the system and the relationships between the primary components. The system architecture in FIGS. 4A-4B may be implemented in a data processing system, such as data processing system 200 in FIG. 2.

In one exemplary embodiment of the present invention, the policy management tool may be implemented using IBM® Tivoli Identity Manager™ (TIM), a software application which provides identity management in a business environment by automating the management of employees and all of their interactions with the business. While this invention is directly applicable to Tivoli Identity Manager™, it may also apply to other Tivoli system management products, and may be extended to other IT Systems Management software where a need exists for coordinating multiple perspectives and where a commonsense visual analysis may be augmented by knowledge-based rules to recognize and remove potential conflicts.

Policy management architecture 400 comprises a visualization framework 402 and Intelligent Guidance and Assistance System (IGAS) 404. In this illustrative example, visualization framework 402 is an instantiation of an Eclipse plug-in design using its Graphical Editing Framework. Visualization framework 402 is based on a model-view-controller paradigm, such as MVC paradigm 300 in FIG. 3, to allow for greater flexibility and possibility of re-use. Visualization framework 402 includes layout policies 406, editor 408, commands 410, models 412, and edit parts 414. Layout policies 416 dictate where each model component may be placed in editor 406, which displays the model and provides an edit area to the user. When the user interacts with editor 406, the editor interprets the user interactions and converts the interactions into requests. In response to the requests, commands 408, such as add, delete, modify, etc., are issued to perform the change requested by the user. In performing the requested changes, commands 408 perform the change to the models 412, and the models in turn notify edit parts 414 of changes. Edit parts 414 then update the figure representing the models and displayed to the user accordingly.

Intelligent Guidance and Assistance System 404 is a separate knowledge-based module for prioritizing alternatives to provide best-choice implementation options. Although an intelligent system itself cannot entirely determine the best solution for a policy, it can be used to provide configuration guidance and assistance to the user. Under some circumstances, Intelligent Guidance and Assistance System 404 may be altogether deactivated or excluded from the policy management tool.

Intelligent guidance assistance system 404 may participate in the policy management at a variety of levels. Most simplistically, intelligent guidance assistance system 404 may detect syntactic errors in a policy model and raise warnings for incompletely specified objects or internally inconsistent attribute values. A syntactic error may result when relationships created in the policy model are not based on the rules of the application of how objects may fit together. In other words, the expert system locates mistakes the user has made that make the policy model incorrect and thus will not work on the application. This level focuses on localized errors that are easy to detect.

Intelligent guidance assistance system 404 may also analyze the semantic meanings in the relationships in the model and disallows or raises warning for invalid or inconsistent inter-object structures. Intelligent guidance assistance system 404 tries to understand the meaning of policy outlined by the user and notifies the user about whether or not the expert system achieved the pattern. For example, there may be many ways to build a policy model. However, not all of the possible ways to build the model will result in a valid policy from a security perspective, even though the model is syntactically correct and thus a valid model. The expert system determines that although syntactically a user's model may be valid, from a security standpoint, the expert system notifies the user of how the user may fix the model to make it security-valid.

On a more advanced level, intelligent guidance assistance system 404 may search the policy configuration and compare the configuration against a library comprising both bad and best practice patterns. The expert system evaluates the user's configuration against the known practice patterns to determine whether the user has used a best practices technique to implement the policy. If not, the expert system provides intelligent recommendations to the user to improve the policy configuration.

Finally and most involved, intelligent guidance assistance system 404 provides a variety of forms of feedback to the user based on constraints, rules, and patterns in the registry. Intelligent guidance assistance system 404 includes simulation and test component 416. When the expert system and user have resolved any syntactic, semantic meaning, and best practices issues for the policy model, the simulation and test component runs a full simulation of the policy, wherein the policy that the user constructed is tested and feedback is generated as to performance and validity. Simulation and test component provides real test results feedback at the time of configuration of the policy. This level allows for the detailed and realistic data for decision-making in stages of configuration refinement.

In one embodiment, policy management architecture 400 may also include application specific knowledge component 418. Application specific knowledge refers to the information (types of models, figures, icons, labels, etc.) that is specific to the particular application. While visual framework 402 is applicable to the configuration space, application specific knowledge component 418 uses additional information about specific applications to tailor the configuration activity to that application.

Individual users in an organization may assist in the deployment of a security policy. For example, security officers at a high level in the organization may provide information regarding compliance regulations for the security policy, but do not configure the policy themselves. An administrator may also provide information on a vendor-neutral level regarding how to implement the security policy in technology. A deployment engineer, who understands how the particular organization operates and the terminology used in the organization, creates the security policy specific to the organization. Application specific knowledge component 418 relates these individual users conceptual views into a common view (and into an alternate conceptual view), thereby allowing shared understanding between different user groups.

The application specific knowledge is encoded in the ObjectModelTypeRegistry 420. ObjectModelTypeRegistry 420 loads and contains all application-specific object types, relationship types, patterns, rules, constraints and any other advanced knowledge needed to manage application data.

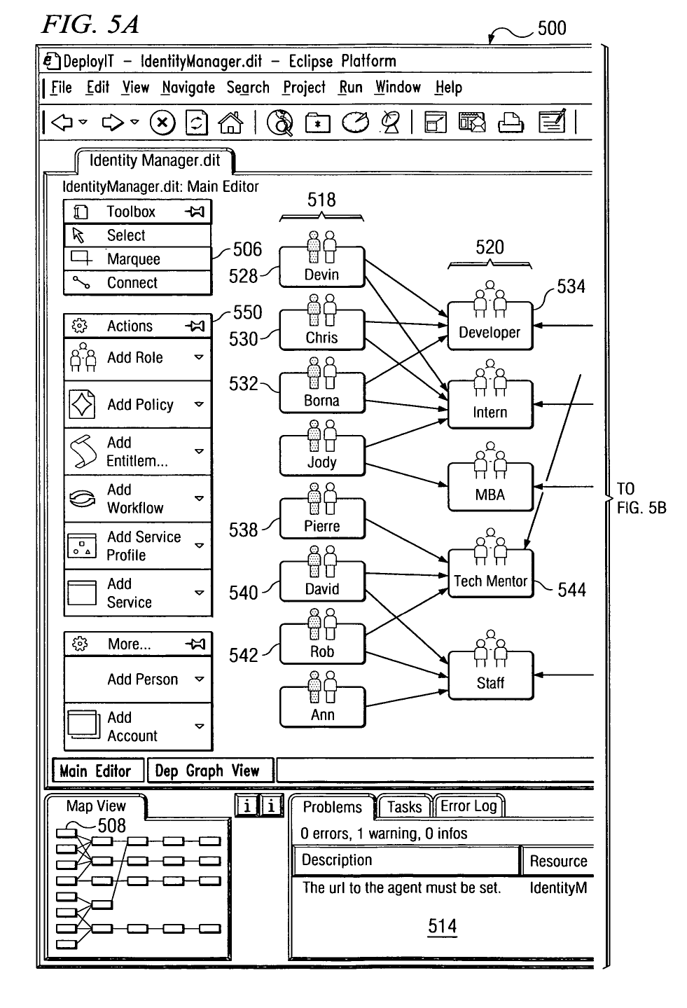

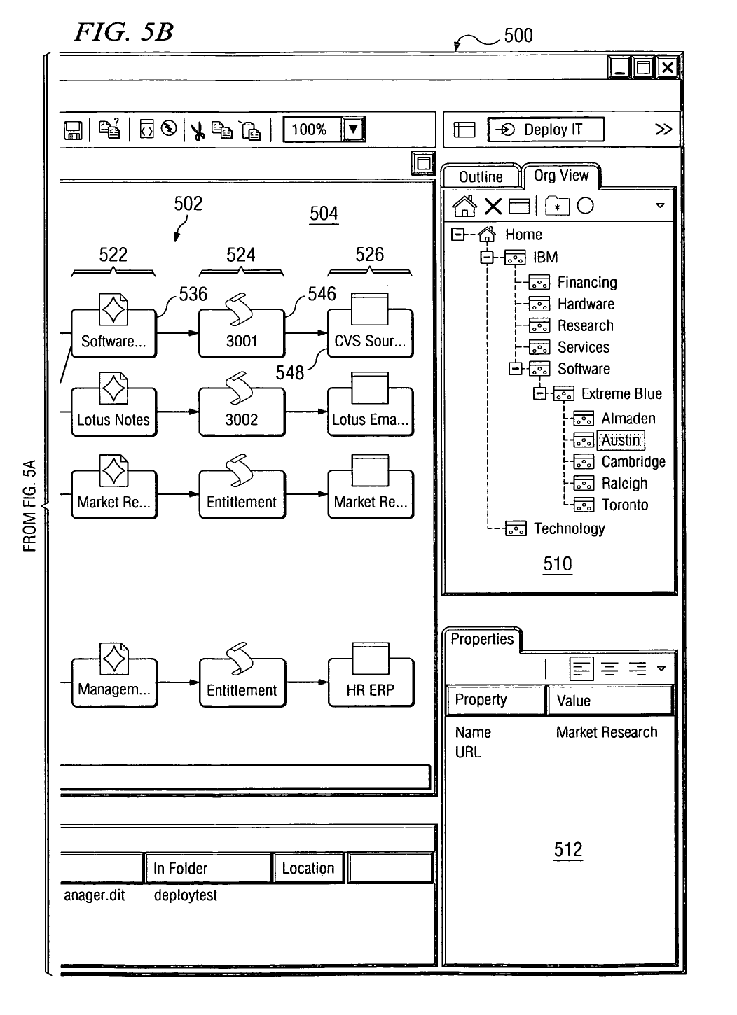

FIGS. 5A-5B depict a diagram of a graphical view in accordance with an illustrative embodiment of the present invention. Graphical view 500 allows users to easily view and modify policy models in an organization. Graphical view 500 may be implemented using editor 408 in visual framework 402 in FIG. 4A, and may be provided to a user within a security management application, such as, for example, Tivoli Identity Manager on an Eclipse platform. A policy model may be created and modified using graphical view 500, or alternatively, an existing policy may be imported into the security management application and modified using the graphical view.

Providing a policy model to a user graphically reduces the complexity of the policy model for the user, since the may visualize the objects and relationships in the policy. This graphical view is especially beneficial in a large organization, as the user cannot be expected to retain the entire model in the user's memory. In addition, the graphical view may reduce the complexity of the model by allowing the user to locate duplicate sets of policies that otherwise would be unknown to the user. For instance, two policies may be present on the organization that provide the same function, but are named differently.

In this illustrative example, graphical view comprises map view 502, editor space 504, toolbox 506, thumbnail zoom view 508, organizational view 510, properties view 512, and problem view 514. Map view 502 in graphical view 500 illustrates the underlying policy model configuration and allows a user to easily see the relationships between the people in the organization and the different objects managing the policy. In this illustrative example, the policy model is a role-based model. Map view 502 includes individuals 518 in the organization, roles 520 in which the people are grouped, policies 522 associated with each role, entitlements 524 of each policy, and services 526 for each entitlement. From map view 502, a user may easily follow the relationship lines to determine which individuals have access to which policies. For example, a user may see that individuals Devin 528, Chris 530, and Borna 532, in a role as developers 534, all have access to software policy 536. Likewise, the user may see that Pierre 538, David 540, and Ron 542, all in a role as technical mentors 544, also has access to software policy 536. Pierre 538, David 540, and Ron 542 also have access to CVS source 548, which is an object representing a resource that they have access to because of the configured connections from entitlement 3001 546. Map view 502 also provides a trouble shooting capability, as the user may immediately see if an individual is incorrectly linked to a policy. For example, if a relationship line is missing from an individual, the user may quickly add the relationship line and make the policy change. In contrast, existing systems require the user to query on a box by box basis to determine whether or not each individual is properly linked, taking much more time.

Modifications to the policy model topology may be performed in editor space 504. Toolbox 506 is provided to represent the various actions 550 which may be applied to objects in editor space 504. Actions 550 are provided in a dynamic palette which represents the various objects in the role-based model that may be dragged onto the editor space 504.

Thumbnail zoom view 508 is a thumbnail view of map view 502. Thumbnail zoom view 508 may be used by the user to aid navigation of map view 502. Organization view 510 is a directory tree that enables the user to navigate the policy objects based on the location of the objects. Organization view 510 is provided to aid in scalability of the policy management tool. Properties view 512 enables the user to directly edit the various attributes of the role-based objects.

Problem view 514 displays problems with the existing policy model that are detected by a knowledge-based system, such as intelligent guidance assistance system 404 in FIG. 4B. Problem view 514 may also provide the user with a prioritization of the best elements of best practice for the various objects of the role-based system.

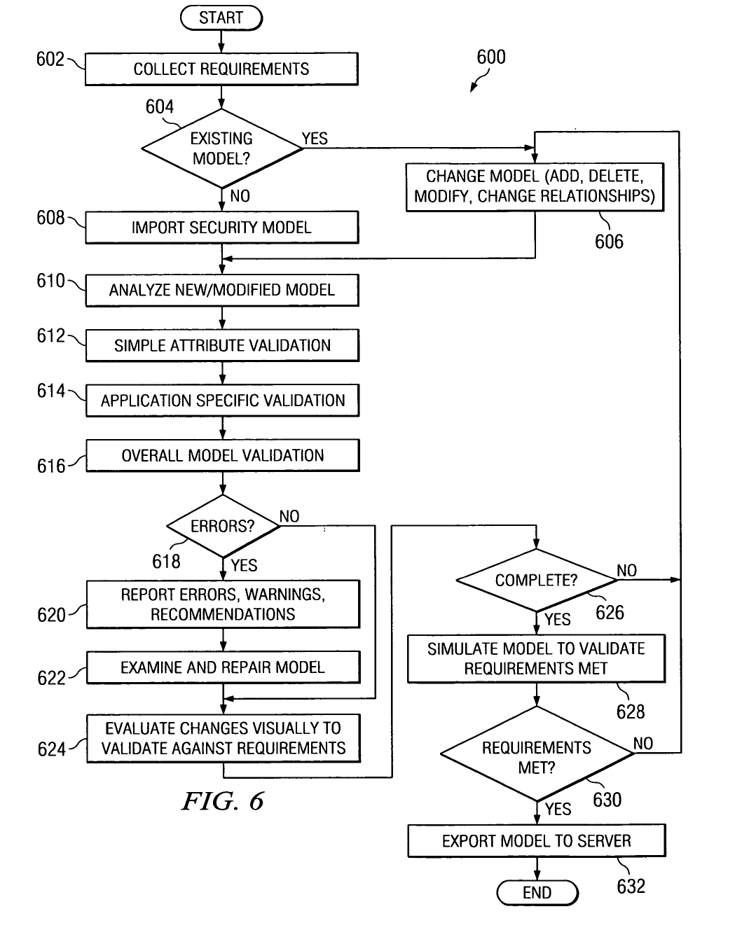

FIG. 6 is a flowchart of a process for reducing implementation time for policy-based system management tools in accordance with an illustrative embodiment of the present invention. The process depicted in FIG. 6 may be implemented using the policy management architecture shown in FIGS. 4A-4B.

The process begins with the policy-management tool collecting requirements for a security policy (step 602). These policy requirements may be collected from various sources. In a typical example, an organization may use the security guidelines created by a security officer in conjunction with the needs of the business functions (e.g., accounting, development, sales, etc.) and compliance regulations to create a list of policy requirements. A determination is then made as to whether the collected requirements pertain to a security policy already existing in the policy management tool (step 604). If the security policy does not exist, a new security policy model is imported into the policy management tool (step 608). Turning back to step 604, if the collected requirements pertain to an existing model, the policy management tool modifies the model (e.g., add, delete, modify relationships) according to the collected requirements (step 606).

Next, the policy management tool analyzes the new or modified model (step 610). Various validations are then performed on the model by the expert system. The expert system first performs a simple attribute validation on the model (step 612). An underlying semantic model that represents the base structure of the application data also contains behavioral annotations. These annotations are leveraged by the expert system in the simple attribute validation to determine if there are problems and/or warnings with the model. The expert system then performs an application specific validation on the model (step 614). The specific validations applied to the model object are dependent upon the application used to implement the policy management tool. Example validations may include, but are not limited to, syntax checking embedded javascript and embedded LDAP filters. The expert system then performs an overall model validation (step 616). The overall model validation examines the overall relationships and attributes of the models for problems. For instance, although the model may be syntactically valid one the surface, the model still may not be logically valid. An example is a policy that provides all employees access to all AIX servers in the company. While the policy is valid syntactically, from a security standpoint, the policy is not valid.

A determination is made as to whether there are errors from any of the validation processes (step 618). If no errors are detected, the process proceeds to step 624. If errors are detected, these errors, as well as any recommendations to remedy the detected errors, are provided to the user (step 620). The policy management tool then examines the reported errors and repairs the policy model accordingly (step 622).

The user evaluates the policy model visually to validate the model against the requirements of the policy (step 624). The policy management tool may visually provide the model to the user using visual framework 402 in FIG. 4A, and present the model via graphical view 500 in FIGS. 5A-5B.

A determination is then made as to whether the policy model in view of the policy requirements is complete (step 626). If the policy model is not complete, the process returns to step 606 and additional modifications to the model may be made. If the policy model is complete, the expert system of the present invention performs a simulation of the model to validate that the policy requirements have been met (step 628). A determination is then made by the expert system as to whether the requirements have been met (step 630). If the expert system determines that the requirements have not been met, the process returns to step 606 and additional modifications to the model may be made. If the requirements have been met, the model is exported back into the server for consumption (step 632), with the process terminating thereafter.

Thus, embodiments of the present invention provide a mechanism for reducing a complicated problem space to enable faster policy implementation in security policy management software. The mechanism of the present invention provides advantages over existing systems that require manual text interfaces to implement policies. By providing a graphical interface for displaying policy models visually, the mechanism of the present invention reduces the time needed for implementing security policies in system software and reduces the complexity of the policy implementation. The expert system of the present invention also prioritizes policy model configuration alternatives to provide best-choice implementation options to users.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W), and digital video disc (DVD).

A data processing system is suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for implementing policies in system software, the computer implemented method comprising:
receiving input from a user to configure a policy model according to a set of policy requirements to form a configured policy model; and
presenting a graphical user interface containing the configured policy model, wherein the graphical user interface allows the user to visualize and modify policy objects and relationships of the configured policy model.

2. The computer implemented method of claim 1, further comprising:
performing validations on the configured policy model against the set of policy requirements.

3. The computer implemented method of claim 2, wherein performing validations on the configured policy model further comprises at least one of monitoring user input to detect potential syntactic problems, analyzing a policy to determine semantic meaning in relationships of the policy, or evaluating configuration techniques used to implement the policy model against best practice patterns.

4. The computer implemented method of claim 2, wherein the validations include at least one of a simple attribute validation, an application specific validation, or an overall policy model validation.

5. The computer implemented method of claim 2, further comprising:
responsive to detecting errors in the validations, providing recommendations to the user to repair the errors.

6. The computer implemented method of claim 5, wherein the recommendations include alerting the user via the graphical user interface as to at least one of syntactic errors, invalid or inconsistent inter-object structures, or alternative configuration techniques consistent with best practice patterns.

7. The computer implemented method of claim 1, further comprising:
performing a simulation when the policy model is configured to determine validity of the configured policy model; and
providing feedback of the simulation to the user.

8. The computer implemented method of claim 1, wherein receiving input from a user to configure a policy model according to a set of policy requirements, further comprises:
determining whether the set of policy requirements pertain to an existing policy model;
if the set of policy requirements do not pertain to an existing policy model, importing a new policy model corresponding to the set of policy requirements into the graphical user interface; and
if the set of policy requirements pertain to an existing policy model, modifying the existing policy model according to the set of policy requirements.

9. The computer implemented method of claim 8, wherein modifying the existing policy model includes at least one of adding, deleting, or changing relationships in the existing policy model.

10. The computer implemented method of claim 1, wherein the graphical user interface allows the user to visually validate the configured policy model against the set of policy requirements.

11. A data processing system for implementing policies in system software, the data processing system comprising:
a bus;
a storage device connected to the bus, wherein the storage device contains computer usable code;
at least one managed device connected to the bus;
a communications unit connected to the bus; and a processing unit connected to the bus, wherein the processing unit executes the computer usable code to receive input from a user to configure a policy model according to a set of policy requirements to form a configured policy model, and present a graphical user interface containing the configured policy model, wherein the graphical user interface allows the user to visualize and modify policy objects and relationships of the configured policy model.

12. The data processing system of claim 11, wherein the processing unit further executes the computer usable code to perform validations on the configured policy model against the set of policy requirements, and provide recommendations to the user to repair the errors in response to detecting errors in the validations.

13. The data processing system of claim 12, wherein performing validations on the configured policy model further includes monitoring user input to detect potential syntactic problems.

14. The data processing system of claim 12, wherein performing validations on the configured policy model further includes analyzing a policy to determine semantic meaning in relationships of the policy.

15. The data processing system of claim 12, wherein performing validations on the configured policy model further includes evaluating configuration techniques used to implement the policy model against best practice patterns.

16. A computer program product for implementing policies in system software, the computer program product comprising:
a computer usable medium having computer usable program code tangibly embodied thereon, the computer usable program code comprising:
computer usable program code for receiving input from a user to configure a policy model according to a set of policy requirements to form a configured policy model; and
computer usable program code for presenting a graphical user interface containing the configured policy model, wherein the graphical user interface allows the user to visualize and modify policy objects and relationships of the configured policy model.

17. The computer program product of claim 16, further comprising:
computer usable program code for performing validations on the configured policy model against the set of policy requirements; and
computer usable program code for providing recommendations to the user to repair the errors in response to detecting errors in the validations.

18. The computer program product of claim 17, wherein the recommendations include alerting the user via the graphical user interface as to invalid or inconsistent inter-object structures.

19. The computer program product of claim 17, wherein the recommendations include alerting the user via the graphical user interface as to alternative configuration techniques consistent with best practice patterns.

20. The computer program product of claim 16, further comprising:
computer usable program code for performing a simulation when the policy model is configured to determine validity of the configured policy model; and
computer usable program code for providing feedback of the simulation to the user.
